(19) United States
(12) Patent Application Publication
(10) Pub. No.: US 2006/0160911 A1
(43) Pub. Date: Jul. 20, 2006

(54) Process for making polyurethane and polyisocyanurate foams using mixtures of a hydrofluorocarbon and methyl formate as a blowing agent

(75) Inventors: Zhen Zhu, Amherst, NY (US); David J. Williams, East Amherst, NY (US); Mary C. Bogdan, Buffalo, NY (US)

Correspondence Address: HONEYWELL INTERNATIONAL INC., 101 Columbia Road, Morristown, NJ, 07962, US

(73) Assignee: HONEYWELL INTERNATIONAL INC.

(21) Appl. No.: 11/385,321

(22) Filed: Mar. 21, 2006

Related U.S. Application Data
(63) Continuation of application No. 10/868,400, filed on Jun. 15, 2004, now abandoned.

(51) Int. Cl. C08G 18/48; C09K 3/00

(52) U.S. Cl. 521/131; 252/182.24

(57) ABSTRACT

A process for preparing polyurethane or polyisocyanurate foam by reacting and foaming a mixture of a polyol, and an isocyanate in the presence of a blowing agent which comprises: i) 22 to 78 mole percent of a hydrofluorocarbon; ii) 22 to 78 mole percent of methyl formate; and iii) 0 to 56 mole percent water.

### CROSS-REFERENCED APPLICATIONS

This application is a Continuation Application of U.S. patent application Ser. No. 10/868,400, filed on Jun. 15, 2004.

### BACKGROUND OF THE INVENTION

1. Field of the Invention

The present invention relates to a mixture of i) 22 to 78 mole percent of a hydrofluorocarbon (e.g., 1,1,1,3,3-pentafluoropropane (“HFC-245fa”)), ii) 22 to 78 mole percent methyl formate, and iii) 0 to 56 mole percent water. The present invention further relates to a process for making a polyurethane or a polyisocyanurate foam using a blowing agent of the mixture.

2. Discussion of the Background Art

The class of foams known as low density rigid polyurethane or polyisocyanurate foam has utility in a wide variety of insulation applications including, but not limited to, roofing systems, building panels, refrigerators and freezers. Polyurethane and polyisocyanurate foams are manufactured by reacting an organic polyisocyanate with a polyol or mixture of polyols, in the presence of a volatile blowing agent or a chemical precursor that produces gas via chemical reaction. Volatile blowing agents are vaporized by the heat liberated during the reaction of isocyanate and polyol causing the polymerizing mixture of foam. This reaction and foaming process may be enhanced through the use of various additives such as catalysts, surfactants, compatibilizers, flame retardants, and other additives that serve to control the reaction rate of the mixture, to control and adjust cell size, to stabilize the foam structure during formation, or to optimize the physical and flammability properties of the final foam product.

The use of a fluorocarbon as the preferred blowing agent in insulating foam applications is based in part on the resulting k-factor associated with the foam produced. K-factor is a measure of the thermal conductivity of the foam and is defined as the rate of transfer of heat through one square foot of a one inch thick material in one hour where there is a difference of one degree Fahrenheit perpendicularly across the two surfaces of the material.

Fluorocarbons act not only as blowing agents by virtue of their volatility, but also are encapsulated or entrained in the closed cell structure of the rigid foam and are the major contributor to the low thermal conductivity properties of rigid urethane foams. Foams made with chlorofluorocarbon blowing agents such as trichlorofluoromethane (“CFC-11”) and hydrochlorofluorocarbons blowing agents such as 1,1-dichloro-1-fluoroethane (“HCFC-141b”) offer excellent thermal insulation, due in part to the very low vapor phase thermal conductivity of CFC-11 and HCFC-141b, and are therefore used widely in insulation applications.

However, the release of certain fluorocarbons, most notably chlorofluorocarbons (“CFCs”) and hydrochlorofluorocarbons (“HCFCs”), to the atmosphere is now recognized as contributing to the depletion of the stratospheric ozone layer. In view of the environmental concerns with respect to CFCs and HCFCs, the use of CFC-11 has been phased out and HCFC-141b is in the process of being phased out and replaced by the zero ozone depletion potential materials such as hydrofluorocarbons (“HFCs”), hydrocarbons, CO₂ produced by the reaction of water with isocyanate, and other materials.

It would be desirable to use zero ozone depletion potential blowing agents, such as water, hydrocarbons and hydrofluorocarbons. However, water is not an optimal blowing agent by itself because foam produced lacks the same degree of thermal insulation efficiency, dimensional stability and adhesion as foam made with CFC or HCFC blowing agents. Hydrocarbon blowing agents may be flammable, and, therefore, less desirable. Because rigid polyurethane foams must comply with building codes or other regulations, such foams expanded with a hydrocarbon blowing agent may require the addition of relatively high levels of expensive flame retardant materials. Also, hydrocarbon blowing agents may be classified as volatile organic compounds (VOC) and be subject to environmental regulation.

Hydrofluorocarbons, especially 1,1,1,3,3-pentafluoropropane (HFC-245fa), offer many of the advantages of the CFC and HCFC blowing agents, including non-flammability, low vapor phase thermal conductivity, safety, and ease of use. And because of the absence of chlorine on the molecule, it does not contribute to the depletion of the Earth's ozone layer.

In order to optimize the overall performance of foam, industry has begun to explore mixtures or blends of blowing agents, many of which contain hydrofluorocarbons. Of particular interest are mixtures containing a hydrofluorocarbon and one or more non-fluorocarbons, all of zero ozone depletion potential. Such mixtures are the subject of this invention.

Methyl formate is a desirable, zero ozone depletion potential blowing agent. However, foam produced using methyl formate as the blowing agent exhibits significant shrinkage and lacks the same degree of thermal insulation efficiency of foam made with the CFC or HCFC blowing agents.

Compositions having a mixture of a hydrofluorocarbon and methyl formate are known in the art. Examples of such compositions include those described in EP Patent 1304349 and U.S. patent application Publication No. 20030114549. EP Patent 1304349 discloses several chemicals including methyl formate as a vapor pressure depressant, used together with HFC-245fa as a blowing agent. The composition range is 0.1-80/20-99.9 weight percent (0.2-90/10-99.8 mole percent) of methyl formate/HFC-245fa. U.S. patent application Publication No.20030114549 discloses 100 weight percent methyl formate, 90-100/0-10 weight percent (73-100/0-27 mole percent) of methyl formate/water and 80-100/0-20 weight percent (90-100/0-10 mole percent of methyl formate/HFC-245fa) of methyl formate/HFCs or HCFCs or CFCs as blowing agents. The present invention provides blowing agent compositions that are not only environmentally safer substitutes for CFCs and HCFCs blowing agents, but that also produce rigid polyurethane and polyisocyanurate foams with unexpectedly good thermal insulation value and physical properties, compared to the compositional ranges described in the prior art.

Moreover, the polyol preblends containing the compositions of the present invention exhibit reduced vapor pressure compared to the polyol preblend containing HFC-245fa blowing agent alone or in combination with water. Reduced polyol blend vapor pressure is an important safety consideration since it is common for these polyol blends to be supplied to the end user in drums. Excessive pressure in the drum can result in unsafe conditions during transportation, handling, and opening of the drums, and in extreme cases, drum failure.

Foams made with the blowing agent compositions of the present invention exhibit improved properties, such as improved thermal insulation efficiency, improved foam dimensional stability and compressive strength, when compared to foams made prior art blowing agents.

### SUMMARY OF THE INVENTION

A blowing agent composition having: i) 22 to 78 mole percent of a hydrofluorocarbon; ii) 22 to 78 mole percent of methyl formate, and iii) 0 to 56 mole percent water (water being optional).

The hydrofluorocarbon is preferably at least one selected from the group consisting of any and all isomers of: pentafluoropropane (HFC-245), difluoromethane (HFC-32); difluoroethane (HFC-152); trifluoroethane (HFC-143); tetrafluoroethane (HFC-134); pentafluoroethane (HFC-125); hexafluoropropane (HFC-236); heptafluoropropane (HFC-227); pentafluorobutane (HFC-365); fluoroethane (HFC-161); difluoropropane (BFC-272); trifluoropropane (HFC-263); tetrafluoropropane (HFC-254); fluoropropane (HFC-281); hexafluorobutane (HFC-356); decafluoropentane (HFC43-10mee); perfluoroethane; perfluoropropane; perfluorobutane; perfluorocyclobutane and difluoropropane. A most preferred hydrofluorocarbon is 1,1,1,3,3-pentafluoropropane (HFC-245fa).

The present invention also includes a process of preparing polyurethane or polyisocyanurate from compositions comprising reacting and foaming a mixture of at least one polyol and an isocyanate, which react to form polyurethane or polyisocyanurate foams in the presence of a blowing agent having i) 22 to 78 mole percent of a hydrofluorocarbon; ii) 22 to 78 mole percent of methyl formate; and 0 to 56 mole percent water.

The process optionally may be carried out in the presence of additional additives selected from the group consisting of: catalysts, surfactants, compatibilizers, dispersing agents, nucleating agents, cell stabilizers, flame retardants, additional polyols, colorants, other ingredients commonly used in the production of polyurethane or polyisocyanurate foams and mixtures thereof.

These ingredients may be added individually to the reaction mixture by suitable metering equipment or methods or by introduction of preblended components. The first component comprises the isocyanate and optionally a surfactant and/or blowing agent, and a second component, which comprises the polyol or polyol mixture and the blowing agent plus other additional additives selected from the group consisting of: catalysts, surfactants, dispersing agents, compatibilizers, cell stabilizers, nucleating agents, flame retardants, additional polyols, colorants, and other materials commonly used in the production of polyurethane or polyisocyanurate foams. Alternatively, a third component may be added to the first and second components, wherein the third component comprises at least one additional additive selected from the group consisting of: catalysts, surfactants, auxiliary blowing agents, dispersing agents, compatibilizers, cell stabilizers, flame retardants, additional polyols, colorants and other materials normally used in the production of polyurethane or polyisocyanurate foams.

According to the preferred method in the present invention, the blowing agent is present in an amount between about 1 to 60 parts by weight of the blowing agent per 100 parts by weight of the polyol. More preferably, the blowing agent is present in an amount of between about 5 to 35 parts by weight of the blowing agent per 100 parts by weight of polyol.

A closed cell foam composition prepared from a polymer foam formulation having a blowing agent composition having: i) 22 to 78 mole percent of a hydrofluorocarbon; ii) 22 to 78 mole percent of methyl formate, and iii) 0 to 56 mole percent water.

A premix of a polyol and a blowing agent wherein the blowing agent has: i) 22 to 78 mole percent of a hydrofluorocarbon; ii) 22 to 78 mole percent of methyl formate; and iii) 0 to 56 mole percent water plus optionally other additives selected from the group consisting of: catalysts, surfactants, dispersing agents, compatibilizers, cell stabilizers, flame retardants, additional polyols, colorants, and other materials commonly used in the production of polyurethane or polyisocyanurate foams.

A polyurethane or polyisocyanurate foam formed by the reaction product of an isocyanate, at least one polyol and at least one blowing agent. The blowing agent has: i) 22 to 78 mole percent of a hydrofluorocarbon; ii) 22 to 78 mole percent of methyl formate, and, ii) 0 to 56 mole percent water plus optionally other additives selected from the group consisting of: catalysts, surfactants, dispersing agents, compatibilizers, cell stabilizers, flame retardants, additional polyols, colorants, and other materials commonly used in the production of polyurethane or polyisocyanurate foams.

### BRIEF DESCRIPTION OF THE DRAWING

The FIGURE is a plot diagram of k-factor for foams made with blowing agents having various levels of methyl formate therein.

### DETAILED DESCRIPTION OF THE PREFERRED EMBODIMENT

The present inventors have developed compositions that can help to satisfy the continuing need for substitutes for CFCs and HCFCs. In one embodiment, the present invention provides compositions comprising at least one hydrofluorocarbon (e.g., 1,1,1,3,3-pentafluoropropane [HFC-245fa]), methyl formate, and, optionally, water.

Preferably, the present invention provides compositions of i) 22 to 78 mole percent of HFC-245fa, ii) 22 to 78 mole percent of methyl formate, and iii) optionally, 0 to 56 mole percent water. The compositions of the invention provide environmentally desirable replacements for currently used CFCs and HCFCs since hydrofluorocarbons, methyl formate, and water all exhibit zero ozone (i.e., stratospheric ozone) depletion potential. Additionally, the compositions of the invention exhibit characteristics that, in some cases, make the compositions more preferred CFC and HCFC substitutes than hydrofluorocarbons, methyl formate or water alone or mixtures of hydrofluorocarbon and water.

More specifically, the invention provides the compositions preferably of from 22 to 78 mole percent hydrofluorocarbon (e.g., HFC-245fa), from 22 to 78 mole percent methyl formate, and from 0 to 56 mole percent water. The preferred, more preferred, and most preferred compositions of the invention are set forth in Table 1. The methyl formate is preferably present at 35 to 65 mole percent and most preferably present at 55 to 65 mole percent.

TABLE 1

| | Preferred | More Preferred | Most Preferred |
|---|---|---|---|
| Components | (mol %) | (mol %) | (mol %) |
| HFC-245fa | 22-78 | 35-65 | 35-45 |
| Methyl Formate | 22-78 | 35-65 | 55-65 |
| Water | 0-56 | 0-30 | 0-10 |

The mixtures in accordance with the present invention are particularly suitable as foam blowing agents since foams blown with hydrofluorocarbon, such as HFC-245fa, have been found to possess low initial and aged thermal conductivity and good dimensional stability, especially at low temperatures. Of particular interest are the compositions that contain methyl formate and further contain other zero ozone depleting blowing agents, such as hydrofluorocarbons. Hydrofluorocarbons include, but are not limited to any and all isomers of difluoromethane (HFC-32), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227), pentafluorobutane (HFC-365), HFC-32, HFC-161, HFC-272, HFC-263, HFC-254, HFC-281, HFC-356, HFC-43-10mee, perfluoroethane, perfluoropropane, perfluorobutane, perfluorocyclobutane, and difluoropropane or blends thereof.

The mixtures in accordance with the present invention can be preblended and then added to the polyol preblend or foam reaction mixture. Alternatively, the individual components of the mixture can be added as individual components to the polyol preblend or reaction mixture.

HFC-245fa is a known blowing agent and can be prepared by methods known in the art, such as those disclosed in WO 94/14736, WO 94/29251, WO 94/29252 and U.S. Pat. No.5,574,192, all of which are incorporated herein by their entirety.

Another aspect of the present invention is the greatly reduced vapor pressure of polyol preblends containing the blowing agent compositions of the present invention. The polyol preblends containing hydrofluorocarbon such as HFC-245fa, often exhibit vapor pressure higher than what is considered safe for shipping in standard shipping containers, most commonly drums. The polyol preblends containing the more preferred compositions of the present invention show at least about 30 percent vapor pressure reduction, compared to polyol preblends containing only HFC-245fa. In certain preferred embodiments, the polyol preblends containing the blowing agent compositions of the present invention show greater than about 45 percent vapor pressure reduction than the polyol preblends containing HFC-245fa. Therefore, the polyol preblends containing the blowing agent compositions of the present invention can be safely shipped in standard shipping containers.

Additionally, the thermal conductivity, or k-factor of foams prepared using the compositions of the invention is lower, hence superior, when compared to the thermal conductivity of foam prepared using methyl formate or water alone, or mixtures of hydrofluorocarbon and water as the blowing agent. Improved dimensional stability and compressive strength are also observed.

In another process embodiment, the compositions of the invention are used in a method for producing polyurethane and polyisocyanurate foams. Such method is any of the methods well known in the art such as those described in “Polyurethanes Chemistry and Technology,” Volumes I and II, Saunders and Frisch, 1962, John Wiley and Sons, New York, N.Y. In general, the method comprises preparing polyurethane or polyisocyanurate foams by combining an isocyanate, a polyol or mixture of polyols, a blowing agent or mixture of blowing agents, and other materials, such as catalysts, nucleating agents, surfactants, and, optionally, flame retardants, colorants, or other additives. The blowing agent or agents employed shall be a mixture of the compositions of the present invention.

It is convenient in many applications to provide the components for polyurethane or polyisocyanurate foams in preblended formulations. Most typically, the foam formulation is preblended into two components. The isocyanate and, optionally, certain surfactants and blowing agents comprise the first component, commonly referred to as the “A” or “iso” component. The polyol or polyol mixture, surfactant, catalysts, blowing agents, flame retardant, and other isocyanate reactive components comprise the second component, commonly referred to as the “B”, or “polyol” or “resin” component. Accordingly, polyurethane or polyisocyanurate foams are readily prepared by bringing together the A and B components either by hand mix for small preparations and, preferably, machine mix techniques to form blocks, slabs, laminates, pour-in-place panels and other items, spray applied foams, froths, and the like. Optionally, other ingredients, such as colorants, auxiliary blowing agents, and even other polyols can be added as a third stream to the mix head or reaction site. Most conveniently, however, they are all incorporated into one B component as described above.

Dispersing agents, cell stabilizers, and surfactants may also be incorporated into the blowing agent mixture. Surfactants are added to serve as cell stabilizers. Some representative materials are sold under the names of DC-193, B-8404, and L-5340 that are, generally, polysiloxane polyoxyalkylene block co-polymers such as those disclosed in U.S. Pat. Nos. 2,834,748, 2,917,480, and 2,846,458, all of which are incorporated herein by reference in their entirety. Other optional additives for the blowing agent mixture may include flame retardants such as tris (2-chloroethyl) phosphate, tris (2-chloropropyl)phosphate, tris (2,3-dibromopropyl)-phosphate, tris (1,3-dichloropropyl)phosphate, various halogenated aromatic compounds, and the like.

Generally speaking, the amount of blowing agent present in the blended mixture is dictated by the desired foam densities of the final polyurethane or polyisocyanurate foam product. The polyurethane foam produced can vary in density from about 0.5 pound per cubic foot to about 40 pounds per cubic foot, preferably from about 1.0 to about 20.0 pounds per cubic foot, and most preferably from about 1.5 to about 6.0 pounds per cubic foot for rigid polyurethane foams. The density obtained is a function of several factors, including amount of blowing agent present in the A and/or B component, or added at the time the foam is prepared.

The blowing agent is used within the range of from between about 1 to about 60 parts by weight of blowing agent per 100 parts by weight of polyol. Preferably, an amount from between about 5 to about 40 parts by weight of blowing agent per 100 parts by weight of polyol is used.

Any organic isocyanate can be employed in polyurethane or isocyanurate foam synthesis inclusive of aliphatic and aromatic isocyanates. Preferred, as a class, are the aromatic isocyanates. Preferred isocyanates for rigid polyurethane or polyisocyanurate foam synthesis are the methylene phenyl isocyanates, particularly the mixtures containing from about 30 to about 85 percent by weight of methylenebis (phenyl isocyanate) with the remainder of the mixture being methylene phenyl isocyanates of functionality higher than 2.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose based polyols used in refrigerator/freezer foam, applications or Mannich base polyols used in spray foam applications.

Catalysts used in the manufacture of polyurethane foams are typically tertiary amines including, but not limited to, N-alkylmorpholines, N-alkylalkanolamines, N,N-dialkylcyclohexylamines, and alkylamines in which the alkyl groups are methyl, ethyl, propyl, butyl and the like and isomeric forms thereof, as well as heterocyclic amines. Typical, but not limiting, examples are triethylenediamine, tetramethylethylenediamine, bis (2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts can be used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic methyl formates such as stannous octoate, stannous 2-ethylhexoate, stannous laurate, and the like, as well as dialkyl tin salts of carboxylic methyl formates such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic methyl formate salts, and mixtures thereof. Preferred species within the classes are potassium acetate, potassium octoate, and N-(2-hydroxy-5-nonylphenol) methyl-N-methylglycinate.

The components of the composition of the invention are known materials that are commercially available or may be prepared by known methods. Preferably, the components are of sufficiently high purity so as to avoid the introduction of adverse influences on blowing agent properties of the system.

Additional components may be added to tailor the properties of the compositions of the invention as needed. By way of example, stabilizers and other materials may be added to enhance the properties of the compositions of the invention.

The present invention is more fully illustrated by the following, non-limiting examples.

### EXAMPLES 1-5

In examples 1-5, five foams (“Experiment 1”, “Experiment 2”, “Experiment 3”, “Experiment 4” and “Experiment 5”) are prepared. In general the formulations used to prepare these foams are described in Table 2.

The same general procedure commonly referred to as “hand mixing” is used to prepare all foams. A master batch of premix of polyols, surfactant, catalysts, flame retardant and water is prepared in the proportions indicated in Table 2 to insure that all of the foams in a given series are made with the same master batch of premix. The premix is blended in a one-gallon paint can, and stirred at about 1500 rpm with a Conn 2″ diameter ITC mixer until a homogenous blend is achieved.

When mixing is complete, the can containing the mix is covered and placed in a refrigerator controlled at 50° F. The foam blowing agent or pre-blended pair of blowing agents for experiment 1-5 is also stored in pressure bottles and/or glass bottle at 50° F. The isocyanate component is kept in sealed containers at 70° F. For the individual foam preparation, an amount of B-component equal to the formulation weight is weighted into a 32 oz. metal can preconditioned at 50° F. The required amounts of the blowing agent blend, also pre-conditioned to 50° F. are added to the B-component. The contents are stirred for two-minutes with a Conn 2-inch ITC mixing blade turning at about 1000 rpm: Following this, the mixing vessel and contents are reweighed. If there is a weight loss, the blended blowing agents are added to make up the loss. The contents are then stirred for an additional 30 seconds, and the can replaced in the refrigerator.

TABLE 2

| Component (parts | | | | | |
|---|---|---|---|---|---|
| by weight) | Expt 1 | Expt 2 | Expt 3 | Expt 4 | Expt 5 |
| Polyether Polyol 1 | 67.8 | 67.8 | 67.8 | 67.8 | 67.8 |
| Polyester Polyol | 20.0 | 20.0 | 20.0 | 20.0 | 20.0 |
| Amine Polyol | 7.6 | 7.6 | 7.6 | 7.6 | 7.6 |
| Polyether Polyol 2 | 4.6 | 4.6 | 4.6 | 4.6 | 4.6 |
| Surfactant | 1.0 | 1.0 | 1.0 | 1.0 | 1.0 |
| Catalyst | 1.8 | 1.8 | 1.8 | 1.8 | 1.8 |
| Flame Retardant | 12.0 | 12.0 | 12.0 | 12.0 | 12.0 |
| Water | 0.5 | 0.5 | 0.5 | 0.5 | 0.5 |
| HFC-245fa | 26.4 | 17.8 | 8.9 | 3.6 | 0 |
| Methyl formate | 4.0 | 8.0 | 11.9 | 14.3 | 15.9 |
| Isocyanate¹ | 145.0 | 145.0 | 145.0 | 145.0 | 145.0 |
| Index | 110 | 110 | 110 | 110 | 110 |

¹Isocyanate---PMDI: polymeric methylene bis diphenyl isocyanate
Index is the stoichiometric ratio of isocyanate to polyol (plus other ingredients that react with isocyanate) in the formulation

After the contents have cooled again to 50° F., approximately 10 minutes, the mixing vessel is removed from refrigerator and taken to the mixing station. A pre-weighted portion of A-component, isocyanate, is added quickly to the B-component, the ingredients are mixed for 10 seconds using a Conn 2″ diameter ITC mixing blade at 3000 rpm and poured into a 8-inch×8-inch×4-inch cardboard cake box and allowed to rise. Cream, initiation, gel and tack free times are recorded for the individual polyurethane foam samples.

The foams are allowed to cure in the boxes at room temperature for at least 24 hours. After curing, the blocks are trimmed to a uniform size and the foams performance are tested. The results are displayed in Table 3.

In addition, the vapor pressures of polyol premix containing the same compositions of blowing agent as indicated in Table 2 are tested. A master batch of premix of polyols, surfactant, catalysts, flame retardant and water, is prepared and mixed to ensure homogenous blend in the proportions indicated in Table 2. The resin is added to a 3-ounce Fischer-Porter tube, chilled to 10° C. and the required amounts of the blowing agents added. The final liquid level height is about 80% of the container. The system is sealed with a pressure gauge attached to the top of the system. The vapor pressure assembly is heated to the test temperature and well mixed. The system is then placed in a constant temperature oven or bath until a stable reading is achieved. When a stable vapor pressure reading is obtained, it is recorded as static vapor pressure. The sample is then inverted 10 times and the vapor pressure is recorded as dynamic vapor pressure. The results are also displayed in Table 3.

The examples demonstrate that the vapor pressure of these polyol blends can be reduced using the blowing agent compositions of the present invention, when compared to the polyol preblend containing HFC-245fa blowing agent alone. The polyol preblends containing the compositions of the present invention show up to about 55 percent vapor pressure reduction compared to the polyol preblends containing HFC-245fa, as shown in Table 3.

TABLE 3

| | HFC- | | | | | | HFC- |
|---|---|---|---|---|---|---|---|
| Blowing Agent (mol %) | 245fa | Expt 1 | Expt 2 | Expt 3 | Expt 4 | Expt 5 | Z45fa/Water |
| Mol ratio (ignoring water) | | | | | | | |
| HFC-245fa | 100 | 75 | 50 | 25 | 10 | 0 | |
| Methyl Formate | 0 | 25 | 50 | 75 | 90 | 100 | |
| Mol ratio (including water) | | | | | | | |
| HFC-245fa | | 69 | 45 | 23 | 9 | 0 | 45 |
| Methyl Formate | | 23 | 45 | 69 | 81 | 91 | |
| Water | | 9 | 9 | 9 | 9 | 9 | 55 |
| Dynamic Vapor Pressure (psi) | | | | | | | |
| 70° F. | 9.2 | 9.9 | 6.8 | 3.1 | | 0.1 | 2.4 |
| 90° F. | 15.2 | 14.6 | 10.5 | 5.5 | | 1.3 | 6.3 |
| 110° F. | 22.9 | 21.9 | 15.3 | 9.0 | | 3.0 | 13.1 |
| 130° F. | 28.9 | 27.0 | 20.2 | 13.1 | | 4.7 | 20.0 |
| Foam Performance | | | | | | | |
| Initial K-factor | | | | | | | |
| (BTU in/hr ft²° F.) | | | | | | | |
| 40° F. | 0.1306 | 0.1362 | 0.1404 | 0.1432 | 0.1548 | 0.1596 | 0.1502 |
| 75° F. | 0.1474 | 0.1531 | 0.1582 | 0.1607 | 0.1722 | 0.1792 | 0.1688 |
| 110° F. | 0.1653 | 0.1709 | 0.1765 | 0.1784 | 0.1900 | 0.1982 | 0.1886 |
| 1 month K-factor | | | | | | | |
| (BTU in/hr ft²° F.) | | | | | | | |
| 40° F. | 0.1495 | 0.1597 | 0.1622 | 0.1709 | Shrink¹ | Shrink¹ | 0.1687 |
| 75° F. | 0.1667 | 0.1763 | 0.1807 | 0.1876 | Shrink¹ | Shrink¹ | 0.1883 |
| 110° F. | 0.1839 | 0.1930 | 0.1987 | 0.2041 | Shrink¹ | Shrink¹ | 0.2086 |
| Compressive strength | | | | | | | |
| Parallel | 24.2 | 33.5 | 25.5 | 31.0 | Shrink¹ | Shrink¹ | 33.6 |
| Perpendicular | 14.4 | 14.6 | 12.0 | 13.2 | Shrink¹ | Shrink¹ | 12.0 |
| Dimensional stability | 12 | 9 | 5 | 3 | Shrink¹ | Shrink¹ | 3 |
| (28 days at −29 C., V %) | | | | | | | |

¹Unable to measure quantative values due to severe shrinkage and distortion of the samples.

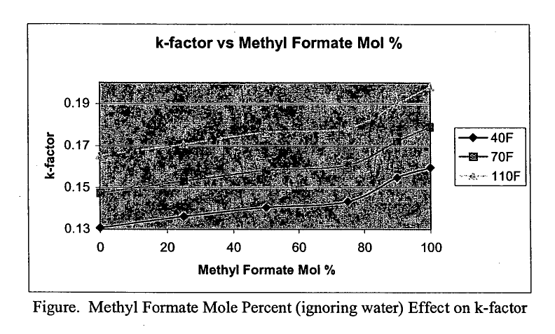

As can be seen from the results in FIG. 1 and Table 3, the use of a composition of the present invention as a blowing agent results in an unexpected thermal insulation value improvement when compared to foam prepared with just methyl formate or water alone, or mixtures of HFC-245fa and water or a mixture of HFC-245fa and methyl formate with more than 78 mole percent of methyl formate in the total blowing agent composition. The foam blown with more than 78 mole percent of methyl formate in the total blowing agent composition lacks the same degree of thermal insulation efficiency, compared to foam made with the composition of the present invention. Moreover, the foam blown with more than 90 mole percent of methyl formate in the total blowing agent composition exhibits significant shrinkage and distortion.

The polyol preblends containing the compositions of the present invention have reduced vapor pressure compared to the polyol preblend containing HFC-245fa blowing agent alone, containing HFC-245fa and water or containing HFC-245fa and methyl formate with less than 22 mole percent of methyl formate in the total blowing agent composition. Surprisingly, the foam blown with less than 22 mole percent of methyl formate in the total blowing agent composition shows significantly poorer dimensional stability compared to foam made with the composition of the present invention.

The foregoing description and examples have been set forth merely to illustrate the present invention and are not intended to be limiting. Since modifications of the disclosed embodiments incorporating the spirit and substance of the invention may occur to persons skilled in the art, the invention should be construed broadly to include all variation falling within the scope of the appended claims and equivalents thereof.

What is claimed is:

1. A blowing agent, comprising:
about 22 to about 78 mole percent of a hydrofluorocarbon;
about 22 to about 78 mole percent of methyl formate, and
0 to about 56 mole percent water based on the total moles of blowing agent.

2. The blowing agent of claim 1, wherein the hydrofluorocarbon is at least one material selected from the group consisting of any and all isomers of the following: difluoromethane, difluoroethane, trifluoroethane, tetrafluoroethane, pentafluoroethane, pentafluoropropane, hexafluoropropane, heptafluoropropane, pentafluorobutane, perfluoroethane, perfluoropropane, perfluorobutane, perfluorocyclobutane, difluoropropane, fluoroethane, difluoropropane, trifluoropropane, tetrafluoropropane, fluoropropane, hexafluorobutane, decafluoropentanel,1,1,3,3-pentafluoropropane and mixtures thereof.

3. The blowing agent of claim 1, wherein the methyl formate is present at about 35 to about 65 mole percent.

4. The blowing agent of claim 1, wherein the methyl formate is present at about 55 to about 65 mole percent.

5. A process for making a polyurethane or a polyisocyanurate foam, comprising the following steps:
mixing a polyol preblend comprising: at least one polyol; optionally, other additives; and a blowing agent having
about 22 to about 78 mole percent of a hydrofluorocarbon,
about 22 to about 78 mole percent of methyl formate, and
0 to about 56 mole percent water based on the total moles of blowing agent in an amount sufficient to form the foam, and
reacting the isocyanate and the polyol preblend to form the foam.

6. The process of claim 5, wherein the hydrofluorocarbon is at least one material selected from the group consisting of any and all isomers of the following: difluoromethane, difluoroethane, trifluoroethane, tetrafluoroethane, pentafluoroethane, pentafluoropropane, hexafluoropropane, heptafluoropropane, pentafluorobutane, perfluoroethane, perfluoropropane, perfluorobutane, perfluorocyclobutane, difluoropropane, fluoroethane, difluoropropane, trifluoropropane, tetrafluoropropane, fluoropropane, hexafluorobutane, decafluoropentane 1,1,1,3,3-pentafluoropropane and mixtures thereof.

7. The process of claim 5, wherein the blowing agent is about 35 to about 65 mole percent methyl formate.

8. The process of claim 5, wherein the blowing agent is about 55 to about 65 mole percent methyl formate.

9. The process of claim 5, wherein the foam is closed cell.

10. A polyurethane or a polyisocyanurate foam comprising a blowing agent, said blowing agent comprising:
about 22 to about 78 mole percent of a hydrofluorocarbon,
about 22 to about 78 mole percent of methyl formate, and
0 to about 56 mole percent water based on the total moles of said blowing agent.

11. The foam of claim 10, wherein the hydrofluorocarbon is at least one material selected from the group consisting of any and all isomers of the following: difluoromethane, difluoroethane, trifluoroethane, tetrafluoroethane, pentafluoroethane, pentafluoropropane, hexafluoropropane, heptafluoropropane, pentafluorobutane, perfluoroethane, perfluoropropane, perfluorobutane, perfluorocyclobutane, difluoropropane, fluoroethane, difluoropropane, trifluoropropane, tetrafluoropropane, fluoropropane, hexafluorobutane, decafluoropentane 1,1,1,3,3-pentafluoropropane and mixtures thereof.

12. The foam of claim 10, wherein said blowing agent is about 35 to about 65 mole percent methyl formate.

13. The foam of claim 10, wherein said blowing agent is about 55 to about 65 mole percent methyl formate.

14. The foam of claim 10, wherein said foam is closed cell.

15. A polyol preblend for making a polyurethane or a polyisocyanurate foam which comprises:
at least one polyol,
a blowing agent comprising: about 22 to about 78 mole percent of a hydrofluorocarbon, about 22 to about 78 mole percent of methyl formate, and 0 to about 56 mole percent water based on the total moles of blowing agent in an amount sufficient to form the foam, and
optionally, other additives.

16. The preblend of claim 15, wherein the hydrofluorocarbon is at least one material selected from the group consisting of any and all isomers of the following: difluoromethane, difluoroethane, trifluoroethane, tetrafluoroethane, pentafluoroethane, pentafluoropropane, hexafluoropropane, heptafluoropropane, pentafluorobutane, perfluoroethane, perfluoropropane, perfluorobutane, perfluorocyclobutane, difluoropropane, fluoroethane, difluoropropane, trifluoropropane, tetrafluoropropane, fluoropropane, hexafluorobutane, decafluoropentane 1,1,1,3,3-pentafluoropropane and mixtures thereof.

17. The preblend of claim 15, wherein said blowing agent is about 35 to about 65 mole percent methyl formate.

18. The preblend of claim 15, wherein said blowing agent is about 55 to about 65 mole percent methyl formate.
